(19) United States
(12) Patent Application Publication
(10) Pub. No.: US 2005/0088524 A1
(43) Pub. Date: Apr. 28, 2005

(54) Lag meter

(76) Inventors: Delmar Bleckley, Lilburn, GA (US); Oswald Drawdy, Atlanta, GA (US); George L. Kelnhofer, Duluth, GA (US)

Correspondence Address: PHILIP H. BURRUS, IV, 460 GRANT STREET, ATLANTA, GA, 30312, US

(21) Appl. No.: 10/691,745

(22) Filed: Oct. 23, 2003

(51) Int. Cl. H04N 5/225

(52) U.S. Cl. 348/207.1

(57) ABSTRACT

A device for measuring various elements associated with a body in motion is provided. One embodiment of the device includes a camera and a second shutter. The second shutter has a shutter speed that is faster than the image capture rate of the camera. The second shutter is coupled to a triggering mechanism. When a moving object passes the triggering mechanism, the second shutter opens for a very small amount of time, thereby enabling the camera to take a clear picture of the moving object at a specific, predetermined time. The picture may then be transmitted to a computer or other video storage means. Software in the computer facilitates measurement of elements associated with the moving body. One exemplary application is the measurement of a golfer's body, club and ball during a golf swing at the moment when the club head contacts the ball. The system allows clear pictures of the golfer to be taken with a traditional video camera.

### BACKGROUND

1. Field of the Invention

This invention relates generally to methods for measuring geometric relationships between constituent components of a body in motion, and more particularly to a method of precisely taking an electronic image of a body in motion at a predetermined time, and measuring elements of the image with an image processor.

2. Background Art

As anyone who has ever attempted to take a picture of a moving car knows, it is quite difficult to take get a clear picture of a moving object. This is especially true when the target is moving very quickly. To get a clear picture, the shutter speed must be precisely set, as must be the position of the camera and the timing of the shutter opening. Additionally, some luck is involved. Any error by the photographer will result in a “blurred” image. The blur is caused by the target image moving across the film while the shutter is open.

Golf professionals know this problem all too well. Many a golf professional has wanted to analyze precise alignments of club shaft, arms, shoulders and legs at the “impact point”, which is the moment when the club head meets the ball. Since the golf swing is quite fast, many golf professionals today use video cameras when teaching. The professionals shoot video images of students, and then replay the images at a slow speed on a video monitor. The reduction in speed helps the professional to detect swing flaws not visible to the naked eye. Frequently, the professional will “pause” the video to analyze a single image.

Unfortunately, video taken with conventional video cameras, when paused, shows only a blurry image like that shown in FIG. 1. The blur is caused by the image capture rate. Video monitors, like conventional television sets, update the information on the screen 60 times per second in accordance with established, progressive scanning, broadcasting standards. (Standards established by the National Television System Committee (NTSC), well known in the art, require video signals to contain intensity information, horizontal retrace signals and vertical retrace signals. The composite of this information is known as the “composite video signal”.) Each update only refreshes half of the screen, however, due to the method of refreshing known as “interlacing”. Consequently, the complete image is effectively renewed 30 times per second.

Conventional analog video cameras take images at a rate of 60 images per second. Each image is used to refresh half of the screen, resulting in a rolling series of half-images that create motion as seen by the human eye. As such, a new “electronic photo” is taken every 16 milliseconds. (Note that purely digital cameras generally take half as many images as do analog cameras, completely refreshing the screen 30 times a second.) In other words, a conventional, analog camera opens its shutter for just under 16 milliseconds and records data, transfers that data to the monitor and briefly closes the shutter, and then repeats the process. The problem with this system is that an object moving as fast as a golf club travels several feet in 16 milliseconds. Consequently, each picture includes blur, as the club travels across the photosensitive portion of the camera while the shutter is open. The blur creates a significant problem in that it is impossible to precisely analyze the golfer when the paused image is not clear.

One prior art solution to the blurry image is a video camera with a very fast shutter speed. These high clarity cameras have shutters that open for a very small amount of time. For example, some video cameras may only open their shutters for as short a time as one 40,000^{th} of a second. The net result, when applied to a golf swing, is a video image that is very clear, as the golf club travels only minimally in one 40,000^{th} of a second.

The problem with these cameras is that they only take these crystal clear images 60 times a second. This is due to the fact that they must be capable of syncing to video monitors and other devices operating per the 60 half-images per second broadcasting standard mentioned above. For the golf professional who wants to look precisely at the impact point, this presents a significant problem, because he has no control over just when the 60 images are taken. While the images may be clear, they may not correspond to the impact point of the golf swing. They may look like the images of FIGS. 2-4, none of which correspond to the impact point.

The only way to sync the impact point with one of the video camera's shutter openings is to video swing after swing until, by chance, the shutter opening happens to correspond to the impact point. This may take 10 swings, 100 swings or more than 1000 swings. A student paying one hundred or more dollars an hour for instruction will not want waste valuable lesson time just trying to sync his swing with the camera.

There is thus a need for an improved method of capturing images of a moving body at a precise point in time for analysis.

### BRIEF DESCRIPTION OF THE DRAWINGS

FIG. 1 illustrates a blurred image of a moving object, as taken by a conventional video camera.

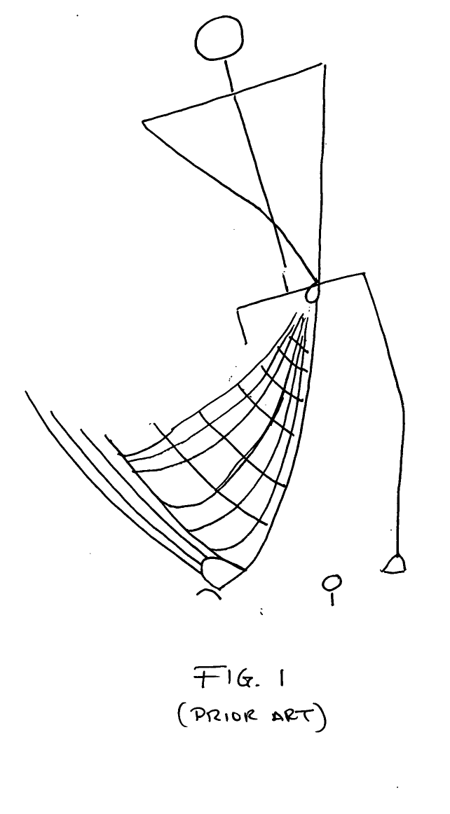

FIGS. 2-4 illustrate images taken with a prior art video camera with a high internal shutter speed.

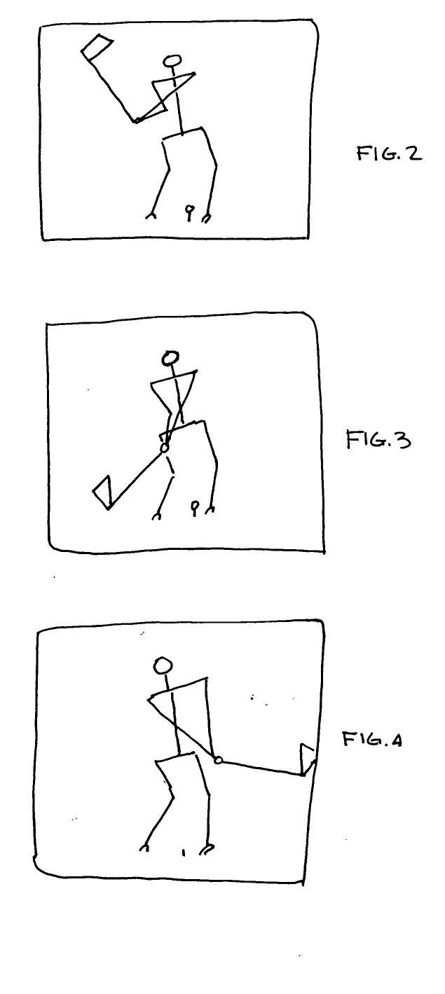

FIG. 5 illustrates one preferred embodiment of a system for measuring geometric relationships of components associated with a body in motion in accordance with the invention.

FIG. 6 illustrates one preferred embodiment of the invention for use with a standard video camera is shown.

FIG. 7 illustrates an electronic image of a person swinging a golf club taken with a system in accordance with the invention.

FIGS. 8-10 illustrate various triggering means in accordance with the invention.

FIG. 11 illustrates an optional means of making the measurement of the spatial relationships between constituent parts of a body in motion.

FIG. 12 illustrates one preferred embodiment of the invention employing a strobe light and corresponding camera.

### DETAILED DESCRIPTION OF THE DRAWINGS

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

This invention provides a system for taking a picture of a moving object at a precise moment. The invention also provides a way of making measurements between constituent components of the moving object, as well as a way of monitoring geometric relationships of components associated with the moving object. Using a golfer for exemplary purposes, the system is capable of recording clear video images precisely at a predetermined time, like the impact point. The invention then provides an image capture system wherein these clear, precise images may be measured. By way of example, a golf professional may use the system to measure the angle between the golfer's leading forearm and club shaft, which represents the amount of “club head lag” at impact. (Club head lag is the amount that the club head trails the hands during the swing.)

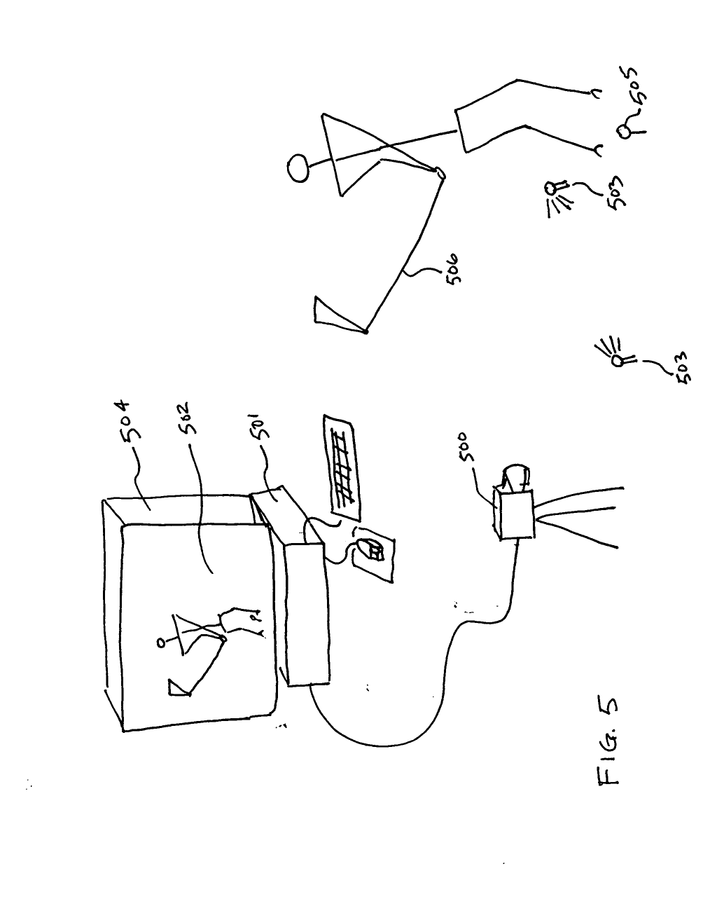

Referring now to FIG. 5, illustrated therein is one preferred embodiment, in accordance with the invention, of a system for measuring geometric relationships of components associated with a body in motion. For discussion purposes, the body in motion will be a person, in particular a golfer, swinging a golf club, although the invention is not so limited. It will be obvious to those of ordinary skill in the art that other moving objects may also be analyzed with the invention.

A means for generating a video or electronic image 500, for example an electronic camera, is coupled to a computer 501. The computer 501 is equipped with a video card, or equivalent hardware, capable of storing the video image 502 generated by the camera. A monitor 504 may be coupled to the computer 501 for displaying the image 502. Note that while a computer 501 is a convenient means for storing and displaying the image 502, sophisticated videocassette recorders or other video imaging hardware will also suffice.

The camera 500 is coupled to a triggering means 503. The triggering means 503 may be as simple as a pair of infrared transmitter/sensors that actuate the camera 500 when an object passes between the triggering means 503. Other types of triggering means 503, as discussed below, may be equivalently substituted for the infrared triggering means.

The triggering means 503 are placed a distance behind the desired picture point, which in this case is a point slightly above the ball 505. The distance is chosen to be commiserate with the actuation speed of the triggering means 503. For instance, if the triggering action is instantaneous, the triggering means 503 will be positioned right at the desired picture point (when the ball is in contact with the clubface—i.e., the “impact point” in FIG. 5). A slower triggering means 503, however, will need to be placed farther away from the desired picture point so that the picture will be taken when the moving object has reached the desired picture point.

When an object, like a golf club 506 for example, actuates the triggering means 503, the camera 500 generates an electronic image (i.e., takes a picture). It is preferred to use a very high shutter speed, thereby taking the clearest picture of the moving object. The picture, or electronic image, is then transmitted—either by wire, RF, or other equivalent communications means—to the computer 501. The computer 501 is equipped with an appropriate video card and memory so as to be capable of storing the electronic image.

Software running in the computer 501, like a Computer Aided Design (CAD) package for example, is capable of importing the electronic image and creating a graphic overlay atop the electronic image. Once the electronic image is loaded, a measuring tool provided by the software provides a means to measure a geometric relationship between at least two elements of the electronic image.

By way of example, one geometric relationship of interest to golfers is the amount of lag in the golf swing. As mentioned above, lag is defined as the amount that the club head trails the hands through the point of impact. One determines the amount of lag by measuring the angle (in the case of a right handed golfer) between the left forearm and club shaft at the impact point.

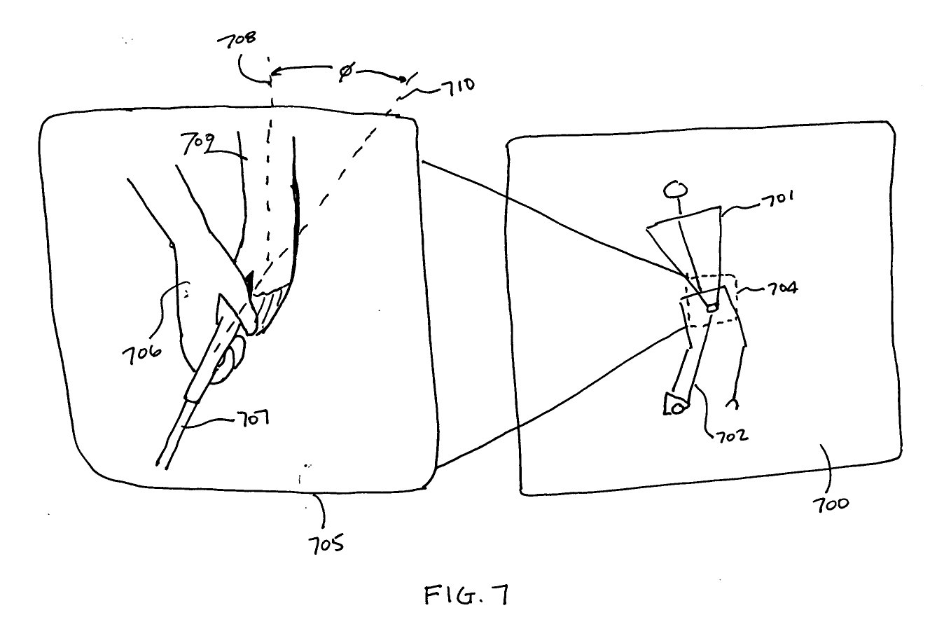

Referring now to FIG. 7, illustrated therein is an electronic image 700 of a person 701 swinging a golf club 702 in accordance with the invention. A portion 704 of the electronic image 700 has been enlarged for clarity. The enlarged portion 705 illustrates the golfer's hands 706 and club shaft 707. To determine the amount of lag, one loads the electronic image into the proper software. In one preferred embodiment, the software comprises a CAD package with an angle measurement function. By drawing a first line 708 along the golfer's left arm 709 (for a right handed golfer), and a second line 710 along the club shaft 707 and grip, the software is able to accurately measure the angle between the two lines 708,710. As such, the amount of lag may be determined with great precision.

In an alternate embodiment, the measurement may be taken by overlaying a semi-transparent measurement device atop the golfer. For example, if the image is being displayed on a computer, rather than manually drawing lines to take measurements, software may be written that facilitates a semi-transparent window with a measuring gauge, like a protractor, on the screen. By overlaying the semi-transparent window atop the image delivered by the camera, a measurement may be made without drawing lines. Such a measurement technique reduces the time associated with taking a measurement.

Lag is only one example of the geometric relationships that may be measured. With respect to a person executing a physical motion, other elements of interest include the arms, hands, shoulders, legs, feet, wrists, head, spine, waist and breastbone. Further, the invention is not limited to measuring geometric relationships on people. Other relationships, including alignments of moving machine parts, relationships between two moving bodies and the like may also be measured.

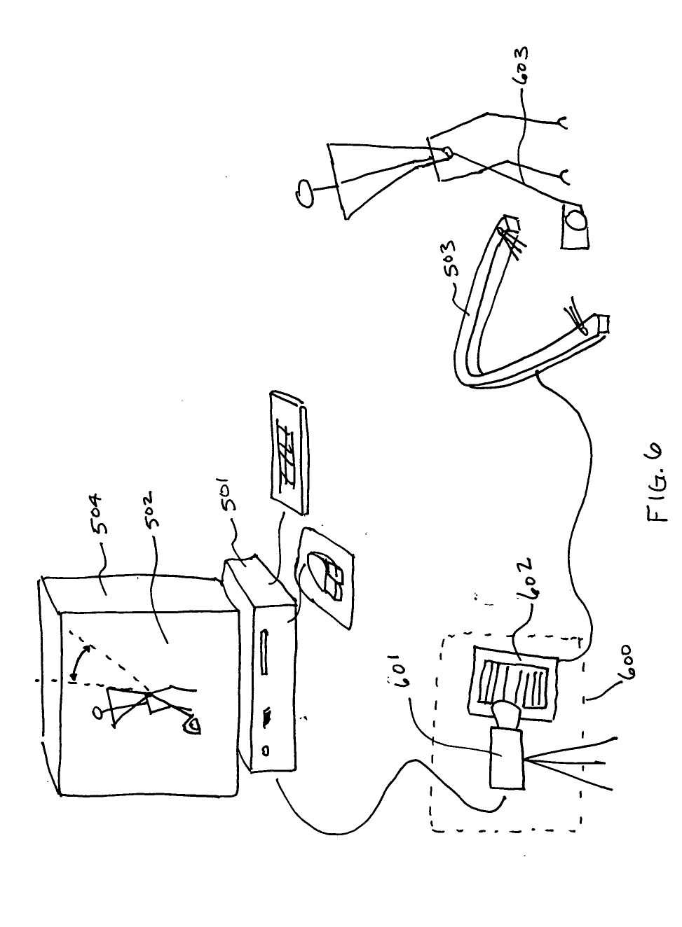

While the digital camera 500 of FIG. 5 works well, one of the most advantageous aspects of the invention is the fact that it may be employed with a standard video camera that operates per the 30 image per second broadcasting standard mentioned above. Referring now to FIG. 6, one preferred embodiment of the invention for use with a standard video camera is shown. Some components are similar in function to those shown in FIG. 6, including the computer means 501, the monitor 504 and the triggering means 503.

The means of generating an image 600, however is different in this embodiment. The means for generating an electronic image 600 comprises a standard video camera 601 having an image capture rate associated therewith, and a second shutter mechanism 602. The video camera 601 operates normally, and may well be running continually, with its images being stored either in the computer 501 or other equivalent image capturing means (like a VCR, for example). When the moving object 603 passes the triggering means 503, the triggering means 503 acts as a means for actuating the second shutter 602, and thus causes the second shutter 602 to open. (Note that the first shutter is considered to be the actual or effective shutter disposed within the video camera 601.) The second shutter 602 the briefly exposes the image sensitive section of the video camera 601 to the image, thereby allowing the video camera 601 to take a clear image at a precise, predetermined point in time. The second shutter 602 may be external to the video camera 601, or may be incorporated therein.

The second shutter 602 is employed because it can be opened very briefly, at a precise instant, as dictated by the triggering means 503. As noted above, exact moment of image acquisition in the video camera 601 is difficult to predict. However, since the video camera's image capture rate is far slower, and thus not equal to, the shutter speed, or “open time”, of the second shutter 602, the image captured by the video camera 601 is simply the image passed through the second shutter 602 during the brief moment in time that the second shutter 602 is open. Thus, the image generated by the second shutter/video camera combination 600 is clear and predictable in time.

A variety of second shutters, including mechanical, electromechanical, and liquid crystal display shutters, may be employed with the invention. One preferred electronic shutter is a Ferroelectric Crystal Display (FCD) shutter, like the VS4900OEM, manufactured by DisplayTech. This shutter works well in that it may be opened for as little as 100 microseconds. Experimental results have shown that the shutter may be opened as quickly as 1/20,000^{th} of a second. This speed is sufficient to capture a clear image of a motor rotating at over 3400 RPM.

Preferred drivers for interfacing the shutter to the triggering means like the DR95 FLC driver, manufactured by DisplayTech. Experimental results have shown that driving the FLC shutter with a short (˜1 usec, less than 10 usec), high voltage (˜15V, greater than 10V) burst, followed by a longer (˜0.1 msec, less than 0.5 msec), lower voltage (˜5V, less than 10V) pulse, shortens the rise time in opening the shutter, thereby offering a quicker actuation time. Thus, while such a shutter will open with a bias voltage of 5V, it is sometimes preferred to lead the bias voltage with a high voltage pulse for clearer images.

Note that the shutter may be opened multiple times per single image capture of the camera. In such a case, multiple, clear images will be overlain atop each other when viewed on a video screen. When a camera is placed above a golfer, geometric phenomena like a gyrating clubhead due to off-center shots may be measured. Additionally, multiple lenses may be employed with the camera, including slotted lenses, mirrors, electromechanically shuttering lenses and ferroelectric crystal display lenses.

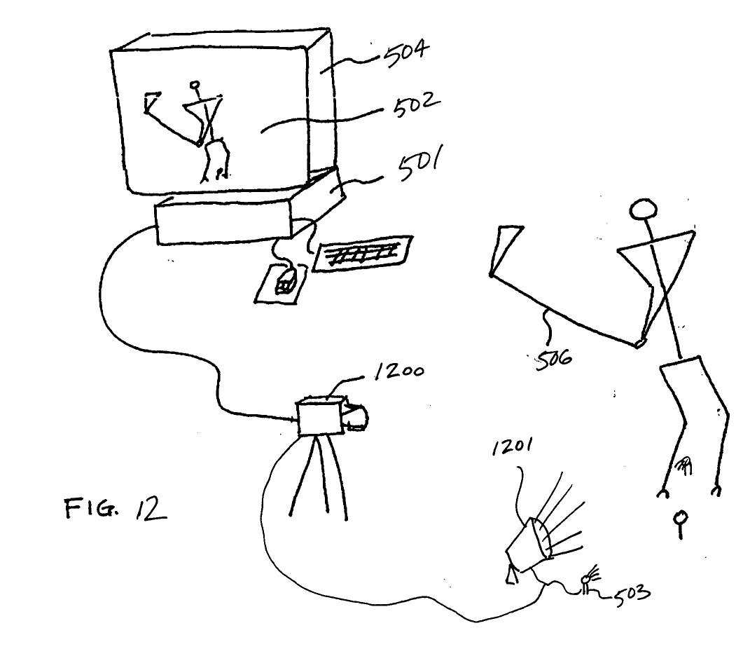

Referring briefly to FIG. 12, illustrated therein is an alternate embodiment of the invention. The computer means 501, the monitor 504, triggering means 503, and club shaft 506 are the same as with FIG. 6. However, in FIG. 12, rather than employing a second shutter, a strobe light 1201 is used. When the club shaft 506 passes through the triggering means, the strobe light 1201 is actuated, thereby providing a briefly illuminated image that may be captured by the camera.

One may immediately react to the concept of a strobe light as being inconvenient, as the environment in which the person were swing the club shaft 506 would need to be dark to allow the strobe light 1201 to briefly illuminate the subject. However, if the strobe light 1201 emits light that is not in the visible spectrum, for example infrared light, the environment need not be kept dark. When using such a special strobe light 1201, a camera 1200 capable of picking up the non-visible light, for example an infrared camera 1200, would need to be used.

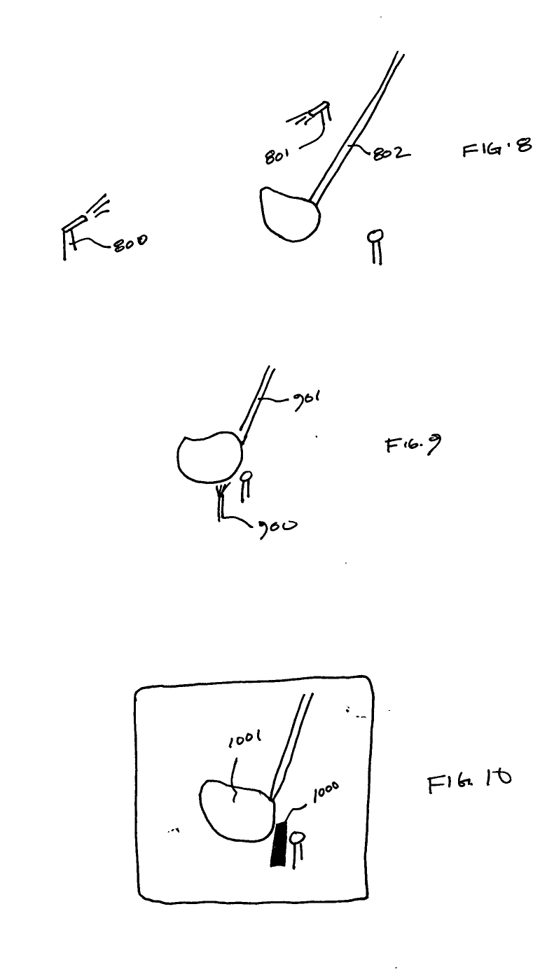

Referring now to FIGS. 8-10, illustrated therein are various triggering means. FIG. 8 illustrates a pair of infrared receptors 800,801. When an object 802 passes through the infrared sensors 800,801, an electronic signal is sent to the image generation means, thereby causing the generation of an image. FIG. 9 illustrates a laser triggering means 900. When an object 901 breaks the beam of the laser 900, an electronic signal is sent to the image generation means.

FIG. 10 illustrates a triggering mechanism that comprises a luminous intensity detection region 1000 as recited in commonly assigned, copending U.S. patent application Ser. No. 10/086,392, filed Mar. 1, 2002, entitled “Ergonomic Motion and Athletic Activity Monitoring and Training System and Method,” which is incorporated herein by reference for all purposes. When an object 1001 passes through the luminous intensity detection region 1000, an electronic signal is sent to the image generation means, thereby causing the image generation means to generate an image. It will be clear to those of ordinary skill in the art that other triggering means, like acoustic sensors, electronic sensors, electromagnetic sensors, and optical sensors may be equally substituted.

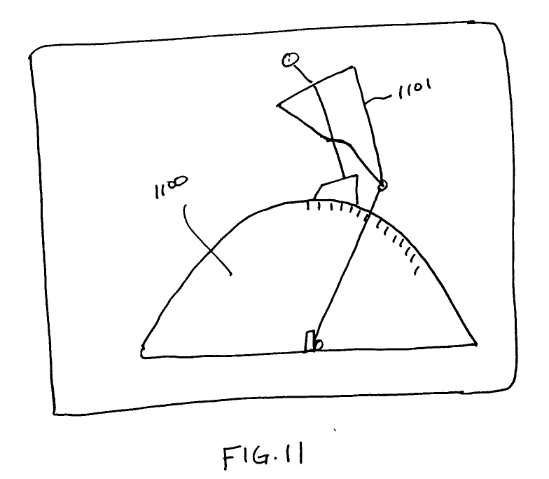

Referring now to FIG. 11, illustrated therein is an optional means of making the measurement of the spatial relationships between constituent parts of a body in motion. While the computer means (referred to with respect to FIGS. 5 and 6) referred to above works well, some users may not have access to such a computer. In the absence of such a device, a rudimentary way of making such a measurement is by including a mechanical measurement device 1100. Continuing with the golfer 1101 and lag measurement as an example, the mechanical measurement device 1100 in this particular embodiment comprises a protractor positioned between the golfer and the ball. As such, when the image generation means takes the picture, a user may simply read the amount of lag off an ordinary means for displaying the video image, like a VCR coupled to a television for example, without the need of sophisticated computer equipment. Other measurement devices could equally be used, including rulers, speedometers, altimeters, and the like.

Note that the foregoing discussion has been directed towards measuring geometric relationships between constituent parts of a body in motion. However, it will be clear to those of ordinary skill in the art that the invention is not so limited. By taking multiple pictures, and knowing the time between exposures, other measurements may be made using the invention. For example, by taking two consecutive pictures, and measuring the distance traveled by the moving object, one may determine the velocity of the moving object by dividing the distance by the time between pictures. Similarly, by taking three pictures, and measuring the change in the distance traveled between the pictures, one may determine the acceleration of the object.

In a case of energy transfer, like a golf club head hitting a golf ball, one may use the velocity measurement from above with respect to both the ball and the club head to determine the efficiency of the energy transfer. With respect to a projectile, like a golf ball for example, one may determine both the speed and direction of the rotation of the projectile. Rotation and speed may be determined by marking the projectile with an identifiable mark, like a stripe. By comparing the position of the stripe in successive images, speed and direction of rotation may be determined.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. For example, while a person hitting a golf ball has been used as an example, numerous other applications where a clear electronic image, at a specific point in time, is desired. Additionally, other measurements, including static position at a given point in time may also be made.

1. A system for measuring geometric relationships of components associated with a body in motion, comprising:
a. a means for generating an electronic image;
b. a triggering means coupled to the means for generating;
c. a computer means coupled to the means for generating, the computer means being capable of storing the electronic image;
d. a software means running on the computer means, the software means being capable of measuring a geometric relationship between at least two elements of the electronic image.

2. The system of claim of claim 1, wherein the body in motion comprises an person, and at least one of the at least two elements is selected from the group consisting of arms, hands, shoulders, legs, feet, wrists, head, spine, waist, and breastbone.

3. The system of claim 2, wherein the person is swinging a golf club, and at least one of the at least two elements is selected from the group consisting of a club head, a golf club grip and a golf club shaft.

4. The system of claim 3, wherein the at least two elements comprise an arm leading a golf swing and the club shaft, further wherein the geometric relationship comprises an angle between the arm leading the golf swing and the club shaft.

5. The system of claim 1, wherein the means for generating comprises:
a. a video camera; and
b. a second shutter;
wherein the triggering means actuates the second shutter.

6. The system of claim 1, wherein the means for generating comprises:
a. a video camera; and
b. a strobe light;
wherein the triggering means actuates both the video camera and the strobe light.

7. A system for measuring spatial relationships relative to a body in motion, comprising:
a. a video camera, the video camera having an image capture rate;
b. a second shutter, the second shutter having a shutter speed that is not equal to the image capture rate;
c. a means for actuating the second shutter; and
d. a means for displaying a video image coupled to the video camera.

8. The system of claim 7, further comprising software means for making spatial measurements between at least two elements of the video image.

9. The system of claim 8, wherein the second shutter is selected from the group consisting of mechanical shutters, electromechanical shutters, ferroelectric crystal shutters and liquid crystal display shutters.

10. The system of claim 7, wherein the means for actuating comprises a sensor selected from the group consisting of electromagnetic sensors, optical sensors, electronic sensors and acoustic sensors.

11. The system of claim 10, wherein the means for actuating comprises a luminous intensity detection region.

12. The system of claim 11, wherein the image capture rate is slower than the shutter speed.

13. The system of claim 12, wherein the body in motion comprises a person executing a physical motion.

14. The system of claim 13, wherein the body in motion comprises a golfer making a golf swing.

15. The system of claim 14, wherein the means for actuating is positioned such that the second shutter is open while a golf ball is in contact with a clubface, further wherein the spatial measurement comprises an angle between the golfer's leading forearm and a club shaft.

16. The system of claim 7, wherein the means for displaying comprises a computer, further wherein the software means comprises video imaging software that allows a user to create a graphic overlay atop the video image, and further allows the user to take angular or linear measurements between components of the graphic overlay.

17. The system of claim 7, wherein when the means for actuating actuates the second shutter, the second shutter opens at least a first and a second times, with a predetermined time interval between the at least a first and the at least a second time, wherein the video camera generates at least a first and a second image.

18. The system of claim 7, further comprising a mechanical measurement device.

19. The system of claim 7, wherein the spatial relationship is selected from the group consisting of angles, velocities, acceleration, deceleration, efficiencies, rotation direction, position and rotational speed.

20. The system of claim 7, wherein the second shutter is driven by a pulse comprising:
a. a leading edge pulse of more than 10V for a duration of less than 5 usec; and
b. a following pulse of less than 10V for a duration of less than 0.5 msec.
